(19) United States
(12) Patent Application Publication
(10) Pub. No.: US 2007/0027256 A1
(43) Pub. Date: Feb. 1, 2007

(54) Styrenic thermoplastics composition

(75) Inventors: Dong-chul Kim, Daejeon (KR); Chan-hong Lee, Daejeon (KR); Sung-je Cha, Seoul (KR); Yun-kyoung Cho, Daejeon (KR); Sung-tae Ahn, Daejeon (KR)

Correspondence Address: CANTOR COLBURN, LLP, 55 GRIFFIN ROAD SOUTH, BLOOMFIELD, CT, 06002, US

(73) Assignee: LG CHEM. LTD., Seoul (KR)

(21) Appl. No.: 10/567,722

(22) PCT Filed: Oct. 8, 2004
(86) PCT No.: PCT/KR04/02572

§ 371 Date: Feb. 8, 2006

(30) Foreign Application Priority Data
Oct. 8, 2003 (KR) 10-2003-0069927

(51) Int. Cl. C08L 51/00

(52) U.S. Cl. 525/70

(57) ABSTRACT

The present invention relates to an acrylic rubber-modified copolymer and the styrenic thermoplastics composition using the same. More particularly, the present invention relates to the styrenic thermoplastics composition having superior appearance and thermoformability, which is obtained by adding 0.5-20 parts by weight of an acrylic rubber-modified copolymer having a rubber particle size ranging from 800 to 6, 000 Åto 100 parts by weight of a resin of 10-50 parts by weight of a graft copolymer comprising rubber-modified styrene and 30-70 parts by weight of a copolymer comprising styrene.

### TECHNICAL FIELD

The present invention relates to an acrylic rubber-modified copolymer and a styrenic thermoplastics composition using the same. More particularly, the present invention relates to a styrenic thermoplastics composition using an acrylic rubber-modified copolymer which has superior appearance and thermoformability and is obtained by adding an acrylic rubber-modified copolymer having a rubber particle size ranging from 800 to 6,000 Å to a mixture resin of a graft copolymer comprising rubber-modified styrene and a copolymer comprising styrene.

### BACKGROUND ART

A rubber-modified styrene resin (referred as an ABS resin) has good impact resistance, toughness, rigidity, chemical resistance, molding processability and luster, etc. Therefore, it is widely used as an extrusion-molding resin for manufacturing OA equipments, household electric appliances, daily commodities, etc. As electronic appliances, particularly refrigerators, are becoming larger and lighter, the rubber-modified styrene resin is sheet-extruded then vacuum-molded and used as an inner cabinet of a refrigerator.

An inner cabinet of a refrigerator is manufactured by extruding a resin sheet and thermoforming the resin sheet to obtain a wanted shape. Therefore, the resin requires good extrusion stability and thermoformability. Also, because it is used in the inner cabinet or door cabinet of a refrigerator, it should also have good appearance characteristics such as luster.

In order to improve thermoformability of a resin, Korea Patent Publication No. 2002-0050475 discloses a method of adding a graft polymer prepared from graft polymerization of a mixture of a vinyl cyanide compound and an aromatic vinyl compound to an acrylic synthetic rubber (referred to as an ‘ASA resin’). However, it has unsatisfactory appearance characteristics such as poor luster.

### DISCLOSURE

In view of these problems, it is an object of the present invention to provide a styrenic thermoplastics composition having superior appearance and thermoformability by adding an acrylic rubber-modified copolymer having a rubber particle size ranging from 800 to 6,000 Å, to a resin comprising a graft copolymer comprising rubber-modified styrene and a copolymer comprising styrene.

It is another object of the present invention to provide an extrusion sheet manufactured from the styrenic thermoplastics composition.

It is also another object of the present invention to provide an acrylic rubber-modified copolymer capable of improving thermoformability and luster of a resin by polymerizing alkyl acrylate as a seed and a core, with alkyl methacrylate and/or alkyl acrylate as a shell, so that the rubber particle size ranges from 800 to 6,000 Å.

The above and other objects of the present invention can be accomplished by embodiments of the present invention as will be described hereinafter.

According to an aspect of the present invention, there is provided a styrenic thermoplastics composition comprising 100 parts by weight of a resin comprising 10-50 parts by weight of a graft copolymer comprising rubber-modified styrene and 30-70 parts by weight of a copolymer comprising styrene; and 0.5-20 parts by weight of an acrylic rubber-modified copolymer having a rubber particle size ranging from 800 to 6,000 Å.

The graft copolymer comprising rubber-modified styrene may comprise 30-65 parts by weight of at least one selected from the group consisting of styrene, α—methylstyrene, p-methylstyrene, vinyltoluene and t-butylstyrene; 10-30 parts by weight of at least one selected from the group consisting of acrylonitrile, methacrylonitrile and ethacrylonitrile; and 10-60 parts by weight of a rubber.

The rubber has a particle size ranging from 500 to 4,000 Åand may be polybutdiene, styrene-butadiene copolymer, polyisoprene or butadiene-isoprene copolymer.

The copolymer comprising styrene may comprise 50-90 parts by weight of at least one selected from the group consisting of styrene, α-methylstyrene, p-methylstyrene, vinyltoluene and t-butylstyrene; and 10-50 parts by weight of at least one selected from the group consisting of acrylonitrile, methacrylonitrile and ethacrylonitrile.

The copolymer comprising styrene may have a weight-average molecular weight ranging from 50,000 to 200,000.

The present invention also provides an extrusion sheet manufactured from the styrenic thermoplastics composition.

The present invention also provides an acrylic rubber-modified copolymer comprising 5-15 parts by weight of a seed polymerized from an alkyl acrylate; 45-75 parts by weight of a core polymerized from an alkyl acrylate; and 10-50 parts by weight of a shell polymerized from an alkyl methacrylate and/or an alkyl acrylate.

The seed may comprise 95.0-9995 wt % of an alkyl acrylate having 2-8 carbon atoms in the alkyl group.

The core may comprise 95.0-9995 wt % of an alkyl acrylate having 2-8 carbon atoms in the alkyl group.

The shell may comprise 90-100 wt % of an alkyl methacrylate having 1-4 alrbon atoms in the alkyl group; and 0-10 wt % of an alkyl acrylate having 1-4 carbon atoms in the alkyl group.

The alkyl acrylate having 2-8 carbon atoms in the alkyl group may be at least one selected from the group consisting of methyl acrylate, ethyl acrylate, propyl acrylate, isopropyl acrylate, butyl acrylate, hexyl acrylate, octyl acrylate, 2-ethylhexyl acrylate, homopolymers thereof and copolymers thereof.

The alkyl methacrylate having 1-4 carbon atoms in the alkyl group may be at least one selected from the group consisting of methyl methacrylate, ethyl methacrylate, propyl methacrylate, isopropyl methacrylate and butyl methacrylate.

The alkyl acrylate having 1-4 carbon atoms in the alkyl group may be at least one selected from the group consisting of ethyl acrylate, methyl acrylate and butyl acrylate.

The acrylic rubber-modified copolymer may have a rubber particle size ranging from 800 to 6,000 Å.

Hereinafter, the present invention is described in more detail.

The present invention provides a styrenic thermoplastics composition comprising 100 parts by weight of a resin comprising 10-50 parts by weight of a graft copolymer comprising rubber-modified styrene and 30-70 parts by weight of a copolymer comprising styrene; and 0.5-20 parts by weight of an acrylic rubber-modified copolymer having a rubber particle size ranging from 800 to 6,000 Å.

Preferably, the present invention provides a styrenic thermoplastics composition comprising a graft copolymer comprising rubber-modified styrene and a copolymer comprising styrene; and 2-13 parts by weight of an acrylic rubber-modified copolymer having a rubber particle size ranging from 3000 to 5,000 Å.

The graft copolymer comprising rubber-modified styrene is a copolymer prepared by grafting a compound comprising 30-65 parts by weight of at least one selected from the group consisting of styrene, a -methylstyrene, p-methylstyrene, vinyltoluene and t-butylstyrene; and 10-30 parts by weight of at least one selected from the group consisting of acrylonitrile, methacrylonitrile and ethacrylonitrile to 10-60 parts by weight of a rubber.

The rubber may be polybutdiene, styrene-butadiene copolymer, polyisoprene, or butadiene-isoprene copolymer, etc. It has a rubber particle size ranging from 500 to 4,000 Å.

Although a graft copolymer comprising rubber-modified styrene may be polymerized by the conventional method, it is preferably synthesized by bulk polymerization or emulsion polymerization. The graft copolymer comprising rubber-modified styrene may have a weight-average molecular weight ranging from 50,000 to 150,000.

Preferably, the graft copolymer comprising rubber-modified styrene is an acrylonitrile/butadiene/styrene (ABS) resin obtained by grafting acrylonitrile and styrene to a butadiene rubber.

The copolymer comprising rubber-modified styrene is comprised in 10-50 parts by weight per the total weight of the styrene thermoplastic resin.

The copolymer comprising styrene comprises 50-90 parts by weight of at least one selected from the group consisting of styrene, α-methylstyrene, p-methylstyrene, vinyltoluene and t-butylstyrene; and 10-50 parts by weight of at least one selected from the group consisting of acrylonitrile, methacrylonitrile and ethacrylonitrile.

Although the copolymer comprising styrene may be polymerized by the conventional method, it is preferably synthesized by bulk polymerization or emulsion polymerization. The copolymer comprising styrene may have a weight-average molecular weight ranging from 50,000 to 200,000. The copolymer comprising styrene is comprised in 30-70 parts by weight per the total weight of the styrene thermoplastic resin, depending on the content of the graft copolymer comprising rubber-modified styrene.

The acrylic rubber-modified copolymer having a rubber particle size ranging from 800 to 6,000 Å, is comprised in 0.5-20 parts by weight, preferably in 2-13 parts by weight, per 100 parts by weight of a resin comprising a graft copolymer comprising rubber-modified styrene and a copolymer comprising styrene. If its content is below 0.5 parts by weight, thermoformability worsen and if it exceeds 20 parts by weight, appearance characteristics such as luster may worsen.

The styrenic thermoplastics composition of the present invention may be prepared by the conventional blending method.

The styrenic thermoplastics composition of the present invention may further comprise at least one additive selected from the group consisting of a lubricant, a heat stabilizer, an antioxidant, an optical stabilizer, an anti-dropping agent, a pigment, an inorganic filler.

The present invention also provides an acrylic rubber-modified copolymer comprising 5-15 parts by weight of a seed polymerized from alkyl acrylate; 45-75 parts by weight of a core polymerized from alkyl acrylate; and 10-50 parts by weight of a shell polymerized from alkyl methacrylate and/or alkyl acrylate.

That is, the acrylic rubber-modified copolymer is prepared by polymerizing a seed, growing rubber particles by adding a monomer that constitutes a core and adding a monomer that constitutes a shell, so that the shell surrounds the core surface. Resultantly, a latex having a particle size ranging from 800 to 6,000 Åis obtained.

The seed and the core rubber layers comprise 50-90 parts by weight of a rubber monomer and the shell layer comprises 10-50 parts by weight of an alkyl methacrylate and/or an alkyl acrylate monomer(s).

The acrylic rubber-modified copolymer is described in more detail.

Preferably, the acrylic rubber-modified copolymer comprises 5-15 parts by weight of the seed and the seed comprises 95.0-9995 wt % of an alkyl acrylate having 2-8 carbon atoms in the alkyl group. It may further comprise a crosslinking agent.

Also, preferably, the acrylic rubber-modified copolymer comprises 45-75 parts by weight of the core rubber layer and the core rubber layer comprises 95.0-9995 wt % of an alkyl acrylate having 2-8 carbon atoms in the alkyl group. It m further comprise a crosslinking agent.

In the seed and the core, the alkyl acrylate having 2-8 carbon atoms in the alkyl group may be at least one selected from the group consisting of methyl acryl, ethyl acrylate, propyl acrylate, isopropyl acrylate, butyl acrylate, hexyl acrylate, octyl acrylate, 2-ethylhexyl acrylate, homopolymers thereof and copolymers thereof.

The crosslinking agent may be Et least one monomer selected from the group consisting of 1,3-butanediol diacrylate, 1,3-bulanediol dimethacrylate, 1,4-butanediol diacrylate, 1,4-butanediol dimethacrylate, allyl acrylate, allyl methacrylate, trimethylolpropane triacrylate, tetraethylene glycol diacrylate, tetraethylene glycol dimethacrylate and divinylbenzene. Preferably, the crosslinking agent is comprised in 0.05-5.0 wt % per the total weight of monomers in latex.

The acrylic rubber-modified copolymer comprises 10-50 parts by weight of a shell. A monomer constituting the shell comprises an alkyl methacrylate and/or an alkyl acrylate monomer.

The shell is polymerized from 90-100 wt % of Et least one alkyl methacrylate having 1-4 carbon atoms in the alkyl group selected from the group consisting of methyl methacrylate, ethyl methacrylate, propyl methacrylate, isopropyl methacrylate and butyl methacrylate and 0-10 wt % of at least one alkyl acrylate having 1-4 carbon atoms in the alkyl group selected from the group consisting of ethyl acrylate, methyl acrylate and butyl acrylate.

The acrylic rubber-modified copolymer has a rubber particle size ranging from 800 to 6,000 Å, preferably from 3,000 to 5,000 Å. If the rubber particle size is below 800 Å, thermoformability may worsen and if it exceeds 6,000 Å, appearance characteristics such as luster, etc may worsen.

The acrylic rubber-modified copolymer may further comprise an emulsifier and a polymerization initiator.

The emulsifier may be at least one ionic emulsifier selected from the group consisting of a saturated or unsaturated potassium salt of fatty acid, potassium salt of oleic acid, sodium lauryl sulfate and sodium dodecylbenzenesulfonate. Preferably, it is comprised in 0.1-4.0 wt % per the total weight of polymerization monomers.

The polymerization initiator may be at least one selected from the group consisting of ammonium persulfate, potassium persulfate, benzoyl peroxide, azobisbutyronitrile, butyl hydroperoxide and cumine hydroperoxide. Among these, the one that initiates polymerization by pyrolysis or oxidation/reduction is preferable.

The acrylic rubber-modified copolymer may be obtained by coagulating the latex of the acrylic rubber-modified copolymer with an electrolyte, an organic acid or an inorganic acid, filtering and drying it. The electrolyte nay be calcium chloride or a water-soluble magnesium salt such as magnesium sulfite.

Hereinafter, the present invention is described more specifically by examples but the present invention is not limited to or by them.

### BEST MODE

<Preparing step 1-1: Preparation of Graft Copolymer Comprising Rubber-Modified Styrene>

A graft copolymer comprising rubber-modified styrene of LG Chem was acrylonitrile/butadiene/styrene (ABS) obtained by grafting 15 parts by weight of acrylonitrile and 35 parts by weight of styrene to 50 parts by weight a butadiene rubber, by emulsion polymerization.

<Preparing step 1-2: Preparation of Copolymer Comprising Styrene>

A copolymer comprising styrene comprising 70 parts by weight of styrene and 30 parts by weight of acrylonitrile was synthesized by bulk polymerization.

<Preparing step 1-3: Preparation of Acrylic Rubber-Modified Copolymer having rubber particle size ranging from 800 to 6,000 Å>

1) Reaction Step 1: Polymerization of Seed

385.13 g of ion exchange water was put in a reactor. The temperature inside the reactor was raised to 70° C. When the temperature of the ion exchange water reached 70° C., 30.81 g of butyl acrylate, 0.05 g of allyl methacrylate, 0.10 g of 1,3-butanediol dimethacrylate and 16.59 g of a potassium sat solution of unsaturated fatty acid (8 wt % solution) were added at the same time. 8.9 g of potassium persulfate (3 wt %) was added while maintaining the internal temperature of the reactor at 70° C. to polymerize a seed.

2) Reaction Step 2: Polymerization of Core Rubber Layer

924.42 g of ion exchange water, 462.2 g of butyl acrylate, 0.450 g of allyl methacrylate, 0.90 g of 1,3-butanediol dimethacrylate and 74.68 g of an unsaturated fatty acid solution (8 wt % solution) were mixed to prepare a pre-emulsion. After a stable pre-emulsion was obtained, it was continuously added to the seed latex prepared in Reaction step 1 at a constant flow rate for 2 hours. At the sane time, 2.5 g of butyl hydroperoxide (10 wt %) was also added continuously for 2 hours, so that polymerization took place. Then, aging was performed at 70° C. for 1 hour to obtain a core.

3) Reaction Step 3: Polymerization of Shell

60 g of ion exchange water, 123.25 g of methyl methacrylate and 13.8 g of a potassium sat solution of unsaturated fatty acid (8 wt % solution) were mixed to prepare a pre-emulsion. The pre-emulsion and 23.1 g of a potassium persulfate solution (3 wt % solution) were divided in two and added to the latex prepared in Reaction step 2 with an interval of 30 minutes, thereby performing polymerization of a shell. Aging was performed for 1 hour while marinating the internal temperature of the reactor at 70° C. Particle size of the resultant latex was measured with an HPL (Nicomp 370 HPL) by dynamic laser light scattering. The particle size was 4,500 Å.

4) Reaction Step 4: Coagulation of Acrylic Rubber-Modified Copolymer

2 wt % of a sulfuric acid aqueous solution (5 wt % solution) was added to the resultant latex at the sane time to coagulate it. The coagulated mixture was heated to 90° C. After 10 minutes of aging, the mixture was cooled down. The mixture was washed with ion exchange water for 2-3 times to remove byproducts and filtered to obtain a coagulated acrylic rubber-modified copolymer. It was dried at 85° C. for 2 hours using an FBD(fluidized bed dryer) to obtain a powdery acrylic rubber-modified copolymer.

### EXAMPLE 1

2 parts by weight of an acrylic rubber-modified copolymer was mixed with 100 parts by weight of a resin comprising 30 parts by weight of a graft copolymer comprising rubber-modified styrene and 70 parts by weight of a copolymer comprising styrene to prepare the styrenic thermoplastics composition.

### EXAMPLE 2

A styrenic thermoplastic resin composition was prepared in the same manner as in Example 1 except that 4 parts by weight, instead of 2 parts by weight, of the acrylic rubber-modified copolymer was used.

### EXAMPLE 3

The styrenic thermoplastics composition was prepared in the sane manner as in Example 1 except that 6 parts by weight, instead of 2 parts by weight, of the acrylic rubber-modified copolymer was used.

### EXAMPLE 4

The styrenic thermoplastics composition was prepared in the sane manner as in Example 1 except that 12 parts by weight, instead of 2 parts by weight, of the acrylic rubber-modified copolymer was used.

### COMPARATIVE EXAMPLE 1

The styrenic thermoplastics composition was prepared in the sane manner as in Example 1 except that the acrylic rubber-modified copolymer was not used.

### COMPARATIVE EXAMPLE 2

The styrenic thermoplastics composition was prepared in the sane manner as in Example 1 except that 30 parts by weight, instead of 2 parts by weight, of the acrylic rubber-modified copolymer was used.

### EXPERIMENTAL EXAMPLE

Physical properties of the compositions prepared in Examples 1-4 and Comparative Examples 1-2, were measured in accordance with following methods.

Tensile strength was measured according to ASTM D638, luster was measured according to ASTM D2985 and the melt index was measured according to ASTM D1238.

Tensile strength EL high temperature was measured with INSTRON Model No. 4301. Measurement sample was prepared by extruding each pellet measuring 100 mm×100 mm×3.2 mm and cutting the sample to a length of 51 mm, an area of 15 mm² and a measurement area of 6.5 mm². The prepared sample was maintained Et 150° C. for 15 minutes before measurement. Tensile strength at high temperature was measured at rate of 200 mm/min. The higher the tensile strength, the better the thermoformability.

Physical property measurement results for Examples 1-4 and Comparative Examples 1-2 are presented in Table 1 below.

TABLE 1

| | Tensile | | | Tensile strength |
|---|---|---|---|---|
| | strength | Fluidity | Luster | at high temperature |
| | (Kgf/cm²) | (g/10 min) | (%) | (Kgf/cm²) |
| Example 1 | 503 | 4.5 | 80 | 4.1 |
| Example 2 | 510 | 4.8 | 82 | 4.4 |
| Example 3 | 506 | 4.5 | 83 | 4.6 |
| Example 4 | 512 | 4.5 | 86 | 5.1 |
| Comparative | 500 | 4.0 | 76 | 3.7 |
| Example 1 | | | | |
| Comparative | 518 | 3.0 | 70 | 4.5 |
| Example 2 | | | | |

As shown in Table 1, the styrenic thermoplastics of the present invention has better appearance characteristics than those of Comparative Examples 1 and 2, which is confirmed by better luster. Also, the styrenic thermoplastics of the present invention has better thermoformability than those of Comparative Examples 1 and 2, which is confirmed by higher tensile strength a high temperature.

### INDUSTRIAL APPLICABILITY

As apparent from the above description, the acrylic rubber-modified copolymer of the present invention and the styrenic thermoplastics composition using the sane, which is prepared by adding an acrylic rubber-modified copolymer having a rubber particle size ranging from 800 to 6,000 Å to a resin comprising a graft copolymer comprising rubber-modified styrene and a copolymer comprising styrene, is applicable to extrusion sheets and improves appearance and thermoformability.

While the present invention has been described in detail with reference to exemplary embodiments, it will be understood by those skilled in the art that various substitutions and modifications can be made thereto without departing from the spirit and scope of the present invention as defined by the following claims.

1. A styrenic thermoplastics composition comprising:
100 parts by weight of a resin comprising 10-50 parts by weight of a graft copolymer comprising rubber-modified styrene and 30-70 parts by weight of a copolymer comprising styrene;
0.5-20 parts by weight of an acrylic rubber-modified copolymer having a rubber particle size ranging from 800 to 6,000 Å;
5-15 parts by weight of a seed polymerized from an alkyl acrylate;
45-75 parts by weight of a core polymerized from an alkyl acrylate; and
10-50 parts by weight of a shell polymerized from an alkyl methacrylate and/or an alkyl acrylate.

2. The styrenic thermoplastics composition of claim 1, wherein the graft copolymer comprising rubber-modified styrene comprises:
30-65 parts by weight of at least one selected from the group consisting of styrene, α-methylstyrene, p-methylstyrene, vinyltoluene and t-butylstyrene;
10-30 parts by weight of at least one selected from the group consisting of acrylonitrile, methacrylonitrile and ethacrylonitrile; and
10-60 parts by weight of a rubber.

3. The styrenic thermoplastics composition of claim 2, wherein the rubber is polybutadiene, styrene-butadiene copolymer, polyisoprene or butadieneisoprene copolymer having a particle size ranging from 500 to 4,000 Å.

4. The styrenic thermoplastics composition of claim 1, wherein the copolymer comprising styrene comprises:
50-90 parts by weight of at least one selected from the group consisting of styrene, α-methylstyrene, p-methylstyrene, vinyltoluene and t-butylstyrene; and
10-50 parts by weight of at least one selected from the group consisting of acrylonitrile, methacrylonitrile and ethacrylonitrile.

5. The styrenic thermoplastics composition of claim 1, wherein the copolymer comprising styrene has a weight-average molecular weight ranging from 50,000 to 200,000.

6. An extrusion sheet manufactured from the styrenic thermoplastics composition of claim 1.

7. An acrylic rubber-modified copolymer having a rubber particle size ranging from 800 to 6.000 Å, comprising:
5-15 parts by weight of a seed polymerized from an alkyl acrylate;
45-75 parts by weight of a core polymerized from an alkyl acrylate; and
10-50 parts by weight of a shell polymerized from an alkyl methacrylate and/or an alkyl acrylate.

8. The acrylic rubber-modified copolymer of claim 7, wherein the seed comprises 95.0-99.95 wt % of an alkyl acrylate having 2-8 carbon atoms in the alkyl group.

9. The acrylic rubber-modified copolymer of claim 7, wherein the core comprises 95.0-99.95 wt % of an alkyl acrylate having 2-8 carbon atoms in the alkyl group.

10. The acrylic rubber-modified copolymer of claim 7, wherein the shell comprises:
90-100 wt % of an alkyl methacrylate having 1-4 carbon atoms in the alkyl group; and
0-10 wt % of an alkyl acrylate having 1-4 carbon atoms in the alkyl group.

11. The acrylic rubber-modified copolymer of claim 8, wherein the alkyl acrylate is at least one selected from the group consisting of methyl acrylate, ethyl acrylate, propyl acrylate, isopropyl acrylate, butyl acrylate, hexyl acrylate, octyl acrylate, 2-ethylhexyl acrylate, homopolymers thereof and copolymers thereof.

12. The acrylic rubber-modified copolymer of claim 10, wherein the alkyl methacrylate having 1-4 carbon atoms in the alkyl group is at least one selected from the group consisting of methyl methacrylate, ethyl methacrylate, propyl methacrylate, isopropyl methacrylate and butyl methacrylate.

13. The acrylic rubber-modified copolymer of claim 10, wherein the alkyl acrylate having 1-4 carbon atoms in the alkyl group is at least one selected from the group consisting of ethyl acrylate, methyl acrylate and butyl acrylate.

14. (canceled)

15. The acrylic rubber-modified copolymer of claim 9, wherein the alkyl acrylate is at least one selected from the group consisting of methyl acrylate, ethyl acrylate, propyl acrylate, isopropyl acrylate, butyl acrylate, hexyl acrylate, octyl acrylate, 2-ethylhexyl acrylate, homopolymers thereof and copolymers thereof.
